(19) United States
(12) Patent Application Publication
(10) Pub. No.: US 2026/0128661 A1
(43) Pub. Date: May 7, 2026

(54) METHOD FOR MONITORING AND MANAGING CONDUCTION LOSSES IN AN ELECTRONIC CIRCUIT

(71) Applicant: SCHAEFFLER TECHNOLOGIES AG & CO. KG, Herzogenaurach (DE)

(72) Inventors: Jacques ROCHER, Toulouse (FR); Yannick LEROY, Toulouse (FR)

(21) Appl. No.: 19/117,539

(22) PCT Filed: Nov. 28, 2023
(86) PCT No.: PCT/EP2023/083372

§ 371 Date: Apr. 1, 2025

(30) Foreign Application Priority Data
Nov. 30, 2022 (FR) 2212535

(51) Int. Cl. H02M 1/00; B60L 53/20; H02M 1/42; H02M 7/797

(52) U.S. Cl. CPC H02M 1/0054; B60L 53/20; H02M 1/4233; H02M 7/797

(57) ABSTRACT

The invention relates to a method for monitoring and managing conduction losses in an electronic circuit comprising at least a first transistor (T1) and a second transistor (T2), the first transistor (T1) and the second transistor (T2) being coupled in parallel, said method comprising:
a first step E1) consisting in commanding the first transistor (T1) so that it switches to a closed-circuit state, and in measuring a first time taken by the first transistor to close (Df_T1) following the command to switch said first transistor (T1) to the closed-circuit state,
a second step E2) consisting in commanding the second transistor (T2) so that it switches to a closed-circuit state, the command to switch the second transistor (T2) to a closed-circuit state occurring after a first determined time TM1,
a third step E3) consisting in commanding the first transistor (T1) so that it switches to an open-circuit state, and in measuring a first time taken by the first transistor to open (Do_T1) following the command to switch said first transistor (T1) to an open-circuit state,
a fourth step E4) consisting in commanding the second transistor (T2) so that it switches to an open-circuit state, the command to switch the second transistor (T2) to an open-circuit state occurring after a second determined time TM2.

### TECHNICAL FIELD

The invention relates to the field of electric motor vehicles and more precisely to a method for monitoring and managing conduction losses in an electronic circuit.

### Prior Art

An electric vehicle generally comprises at least one electric machine, for example an asynchronous electric motor, designed to make at least one wheel of the electric vehicle rotate. It also comprises at least one high-voltage battery, for example an 800 Volt battery, designed to provide electrical energy in order to supply power to the electric machine.

In order to allow the electric motor to be supplied with electrical energy by the high-voltage battery, the electric vehicle also comprises an on-board charger (OBC) connected on the one hand to the high-voltage battery and on the other hand to an electrical supply network. The on-board charger makes it possible to convert an alternating voltage, provided by the electrical supply network, into a direct voltage to charge the battery.

An on-board charger primarily comprises a power factor corrector (PFC) circuit, a DC-DC voltage converter, commonly called a “DC/DC converter”, and a microcontroller capable of commanding the power factor corrector circuit.

In the case of charging the high-voltage battery, the power factor corrector circuit is the element of the on-board charger which converts the alternating voltage, provided by the electrical supply network, into a direct voltage. For example, in the case where the electrical supply network is a three-phase alternating voltage network, the power factor corrector circuit comprises three branches. Each branch, often called a cell, comprises two transistors coupled in series and each cell is coupled to one phase of the alternating voltage.

As mentioned above in the description, the role of the power factor corrector circuit is to transform the alternating voltage into a direct voltage. To do this, the switches or transistors of a cell are commanded so as to switch in a determined order; the cells are themselves also commanded in a determined order so as to rectify the input signal to create a continuous signal at the output of the PFC.

Since the power to be transferred is relatively high, each switch or transistor, during a change of state, incurs “switching” losses which, when they are repeated and not controlled, may cause significant heating of the switches and greatly reduce service life

In order to reduce the power transferred by the transistors, document FR2114069 first of all proposes positioning another transistor in parallel. Thus, such an assembly ingeniously makes it possible to reduce the power per transistor.

In order to limit switching losses, document FR2114069 also proposes an original command strategy for commanding the parallel transistors of a cell. The aim of this method is to first of all make a first transistor of the two transistors coupled in parallel switch and wait a determined time before commanding the second transistor. Thus, it is possible to reduce switching losses during switching of the second transistor. Specifically, since the first transistor is already switched, there is no switching loss for the second transistor.

By virtue of this solution, it is possible to control the conduction losses of a switching cell comprising two transistors coupled in parallel. However, the fixed switching time and more particularly the time delay before switching the second transistor is not optimal with regard to the conduction losses of the first transistor which may cause a drift in the switching time representative of possible wear of said transistor.

### SUMMARY OF THE INVENTION

The invention relates to a method for monitoring and managing conduction losses in an electronic circuit comprising at least a first transistor and a second transistor, the first transistor and the second transistor being coupled in parallel; said method has a first step E1) consisting in commanding the first transistor so that it switches to a closed-circuit state, and in measuring a first time taken by the first transistor to close following the command to switch said first transistor to the closed-circuit state, a second step E2) consisting in commanding the second transistor so that it switches to a closed-circuit state, the command to switch the second transistor to a closed-circuit state occurring after a first determined time TM1, a third step E3) consisting in commanding the first transistor so that it switches to an open-circuit state, and in measuring a first time taken by the first transistor to open following the command to switch said first transistor to an open-circuit state, a fourth step E4) consisting in commanding the second transistor so that it switches to an open-circuit state, the command to switch the second transistor to an open-circuit state occurring after a second determined time TM2, a fifth step E5) consisting in commanding the second transistor so that it switches to a closed-circuit state, and in measuring a first time taken by the second transistor to close following the command to switch said second transistor to the closed-circuit state, a sixth step E6) consisting in commanding the first transistor so that it switches to a closed-circuit state, the command to switch the first transistor to a closed-circuit state occurring after a third determined time TM3, a seventh step E7) consisting in commanding the second transistor so that it switches to an open-circuit state, and in measuring a first time taken by the second transistor to open following the command to switch said second transistor to an open-circuit state, an eighth step E8) consisting in commanding the first transistor so that it switches to an open-circuit state, the command to switch the first transistor to an open-circuit state occurring after a fourth determined time TM4, a ninth step E9) consisting in storing in a memory the values of the first time taken by the first transistor to close, the first time taken by the first transistor to open, the first time taken by the second transistor to close, and the first time taken by the second transistor to open, a tenth step E10) consisting in executing steps E1) to E9) at least n times, and an eleventh step E11) consisting in taking an average of the n measurements of the first time taken by the first transistor to close, an average of the n measurements of the first time taken by the first transistor to open, an average of the n measurements of the first time taken by the second transistor to close, and an average of the n measurements of the first time taken by the second transistor to open, a twelfth step E12) consisting in performing steps E1) to E11) m times, and a thirteenth step E13) consisting in comparing the m values of the respective n averaged values.

By virtue of the invention and its method, it is possible to detect a drift in the switching time of at least one transistor.

In one exemplary embodiment, when at least one result of the comparison of the m values drifts from the average value by p % then a software alert is generated.

Alternatively, when a result of the comparison of the m values of the n averaged values of the first time taken by the first transistor to close, or the m values of the n averaged values of the first time taken by the first transistor to open, or the m averaged values of the n values of the first time taken by the second transistor to close, or the m averaged values of the n values of the first time taken by the second transistor to open drifts by p % then activate the transistor corresponding to the value that has drifted only after the other transistor.

For example, if the observed drift of the m values of the n averaged values of said transistor activated only second continues a drift similar to that observed, for example of greater than p %, then the method proposes activating a software alert.

Advantageously, if the drift of the m values of the n averaged values of said transistor activated only second has a drift of less than p % then the method proposes activating said corresponding transistor first again.

For example, the value of p % is equal to 10%.

In one exemplary embodiment, if the drift of the m values of the n averaged values of said transistor activated only second has a drift of greater than p % then the method deactivates said transistor.

For example, the function uses a mathematical three sigma method.

For example, at least one of the two transistors is an IGBT transistor.

For example, at least one of the two transistors is an SiC/GaN transistor.

### DESCRIPTION OF THE DRAWINGS

Other features and advantages of the invention will become more clearly apparent on reading the following description. This description is purely illustrative and should be read with reference to the appended drawings, in which:

FIG. 1 is an illustration of a charger according to the invention,

FIG. 2 shows a circuit diagram of a power factor corrector circuit of a charger according to FIG. 1,

FIG. 3 shows an illustration of the method according to the invention,

FIG. 4 shows the change, as a function of time, in the open or closed states of a set of switches of the power factor corrector circuit.

### DESCRIPTION OF THE EMBODIMENTS

The invention will be presented in the case of an implementation in an electric vehicle comprising at least one electric machine capable of converting electrical energy into mechanical energy in order to drive at least one wheel of the electric vehicle to rotate.

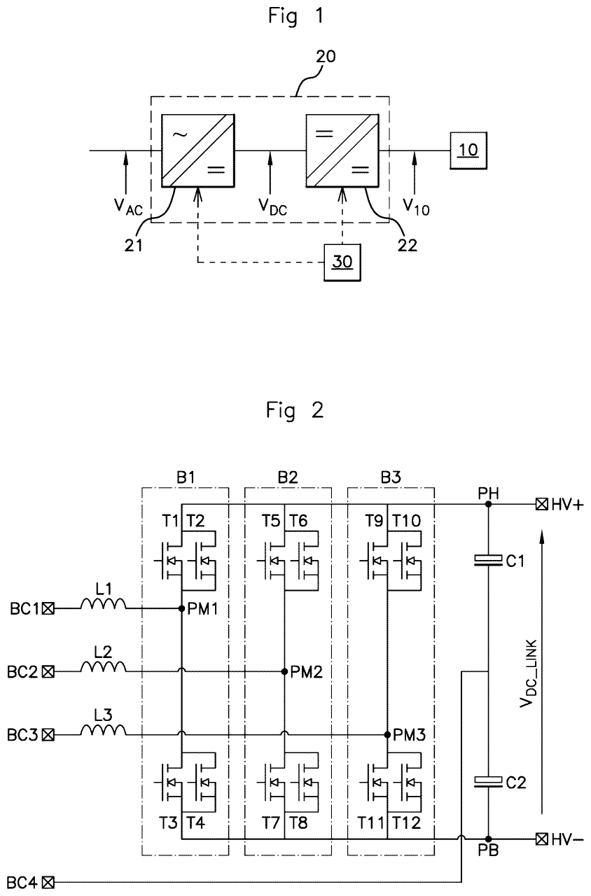

With reference to FIG. 1, the electric vehicle comprises an electrical supply battery 10 and an electric system comprising an on-board charger 20 and a microcontroller 30.

The electrical supply battery 10 is in particular capable of operating in a discharge mode in which the electrical supply battery 10 supplies electrical energy to equipment installed in the electric vehicle. The electrical supply battery 10 is also capable of operating in a charge mode in which it is capable of being charged from electrical energy provided by an electrical network. For example, the voltage of the electrical supply battery 10 may be 400 V or 800 V. For example, the electrical network is capable of delivering a voltage of 220 Volts AC or 380 Volts.

The on-board charger 20 (OBC) is connected to the electrical supply battery 10, to at least one piece of equipment installed in the electric vehicle and to the electrical network via connection means.

In one exemplary embodiment, the on-board charger 20 is called “bidirectional”. Thus, when the on-board charger 20 is connected to the electrical network and the electrical supply battery 10 needs to be recharged, the on-board charger 20 is capable of converting the alternating voltage provided by the electrical network into a direct voltage capable of charging the electrical supply battery 10.

More precisely, the on-board charger 20 comprises a power factor corrector circuit 21 and a DC-DC voltage converter 22 also called a DC-DC converter 22. The DC-DC converter 22 is electrically connected to the power factor corrector circuit 21 via a suitable wire coupling.

In addition, the DC-DC converter 22 is designed to be electrically connected to the electrical supply battery 10 and the power factor corrector circuit 21 is designed to be electrically connected to a piece of equipment of the vehicle or outside the vehicle or to the electrical network via connection means which are not shown.

Still with reference to FIG. 1, the power factor corrector circuit 21 is capable of converting an alternating voltage V_{AC} into a direct voltage V_{DC} and vice versa. It is therefore bidirectional.

The DC-DC voltage converter 22 is capable of converting the direct voltage V_{DC} into another direct voltage V₁₀. For example, when the electrical supply battery 10 operates in the charge mode, the power factor corrector circuit 21 is connected to an electrical network and the power factor corrector circuit 21 thus transforms the alternating voltage V_{AC} provided by the electrical network into a direct voltage V_{DC} of a value for example of 650 Volts. Finally, the DC-DC voltage converter 22 transforms the direct voltage V_{DC} into a direct voltage V₁₀ suitable for recharging the electrical supply battery 10. For example, the direct voltage has a value of 400 Volts or 800 Volts.

Conversely, when the electrical supply battery 10 operates in the discharge mode, meaning that the power factor corrector circuit 21 is connected to a piece of electronic equipment in order to supply power to, for example, a games console installed in the vehicle, the DC-DC voltage converter 22 then transforms the direct voltage V₁₀ provided by the electrical supply battery 10 into another direct voltage V_{DC}. For example, the other direct voltage has a value of around 650 Volts. Finally, the power factor corrector circuit 21 transforms the direct voltage V_{DC} defined substantially at 650 Volts into an alternating voltage V_{AC} capable of supplying electrical energy to the equipment connected to said power factor corrector circuit 21, in this instance, as mentioned above, the games console.

With reference to FIG. 2, the detailed electronic structure of the power factor corrector circuit 21 will now be presented in the case where the electrical network is a three-phase network. The electrical network therefore comprises three connection terminals, and optionally a neutral terminal. In another exemplary embodiment of the invention, in the case where the electrical network is a single-phase network, i.e. 220 V, then the circuit has only two connection terminals.

In the present case, the power factor corrector circuit 21 comprises a first branch B1 or cell, a second branch B2, and a third branch B3. A first coil L1 is electrically connected to a first connection terminal BC1 of the electrical network. The first connection terminal BC1 may be the phase of one of the three phases of the three-phase network.

The first branch B1 comprises a first set of transistors and a second set of transistors. Each set of transistors comprises at least two transistors connected in parallel. In order to simplify the description, the first and second sets of transistors each comprise two transistors connected in parallel. Thus, the first set of the first branch B1 comprises a first transistor T1 and a second transistor T2 connected in parallel between a high point PH and a first midpoint PM1. The second set comprises a third transistor T3 and a fourth transistor T4 connected in parallel between a low point PB and the first midpoint PM1. The first midpoint PM1 is electrically connected to the first connection terminal of the electrical network BC1 or of the electrical equipment connected to the charger 20 via the first coil L1.

The power factor corrector circuit 21 also comprises a second branch B2 the structure of which is similar to that of the first branch B1. Thus, the second branch B2 comprises a fifth transistor T5 and at least a sixth transistor T6 connected in parallel between the high point PH and a second midpoint PM2, the second branch B2 comprising a seventh transistor T7 and at least an eighth transistor T8 connected in parallel between the low point PB and the second midpoint PM2. The second midpoint PM2 is electrically connected to a second connection terminal of the electrical network BC2 by way of a second coil L2.

The power factor corrector circuit 21 finally comprises a third branch B3 the structure of which is similar to that of the first branch B1. Thus, the third branch B3 comprises a ninth transistor T9 and at least a tenth transistor T10 connected in parallel between the high point PH and a third midpoint PM3, the third branch B3 comprising an eleventh transistor T11 and at least a twelfth transistor T12 connected in parallel between the low point PB and the third midpoint PM3. The third midpoint PM3 is electrically connected to a third connection terminal of the electrical network BC3 by way of a third coil L3.

A first capacitor C1 and a second capacitor C2 are coupled in series between the high point PH and the low point PB. Optionally, a fourth terminal BC4 is connected to a fourth midpoint PM4 arranged between the first capacitor C1 and the second capacitor C2.

Advantageously, each of the branches B1, B2, B3 comprises at least two transistors or transistors coupled in parallel, thus making it possible to distribute the losses. The first branch B1, the second branch B2 and the third branch B3 respectively constitute an electronic half bridge.

The microcontroller 30 is capable of commanding the opening and closing of each transistor T1, T2, T3, T4, T5, T6, T7, T8, T9, T10, T11, T12 of the power factor corrector circuit 21. To do this, the microcontroller 30 is capable of transmitting for each transistor a command signal capable of making the duty cycle change as well as the switching frequency, i.e. opening and closing of each transistor. The microcontroller 30 is, for example, a processor capable of implementing a set of instructions which allows these functions to be performed.

As mentioned above, a transistor has a switching time necessary to switch, for example, from a high level (open circuit) to a low level (closed circuit). This switching time is different from one transistor to another transistor and, furthermore, it is likely to change as a function of the temperature but also of the aging of said transistor. Also, the switching time from a high level to a low level is not necessarily identical to a switching time from a low level to a high level.

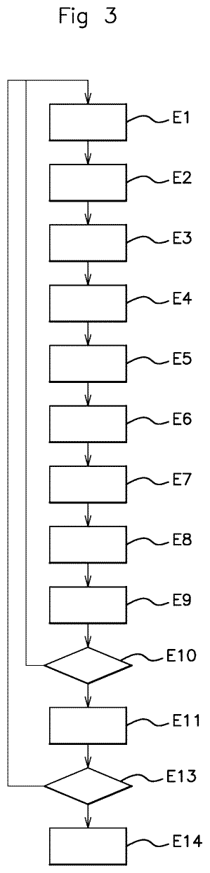

One embodiment of the method implemented by the microcontroller 30 will now be described with reference to FIGS. 3, 4 and 5.

The method is described here in the case where it is necessary to command the closing and opening of the first switch T1 and of the second switch T2 connected in parallel. However, the method as described below may also be applied to any set of at least two switches connected in parallel in the power factor corrector circuit 21. Furthermore, any other type of electronic circuit comprising at least two transistors connected in parallel may also be commanded by the method of the invention. In order to simplify the description, the method will be described for a set of two switches such as the first transistor T1 and the second transistor T2 of the first cell B1.

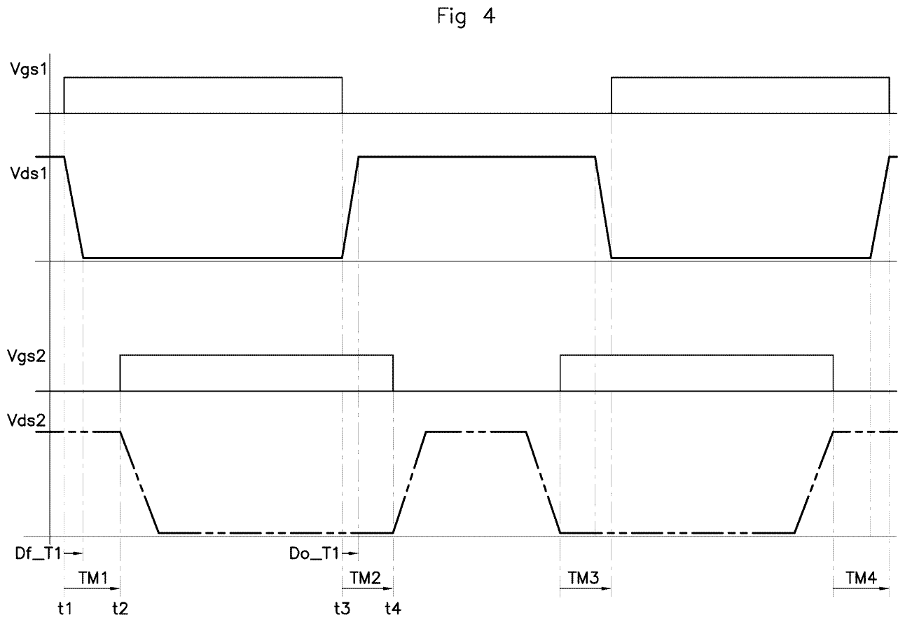

The method comprises a first closing step E1 (FIG. 3) consisting in commanding the first switch T1. To do this, for example, the microcontroller 30 generates a first command signal Vgs1 (FIG. 4) for closing the first switch T1 at a first time t1. The first switch T1 then closes within a time which will be called the first time taken by the first switch to close Df1_T1 which is intrinsic to the first transistor T1 and which corresponds to the switching time of said transistor, that is to say the closing time of the switch (or switching of the transistor) starting from the closing command received (see FIG. 4). Thus, once the first transistor T1 is closed, the midpoint PM1 is coupled to the high point PH.

Advantageously, after a first time TM1 of greater than the first time taken by the first switch to close Df1_T1, in this instance 100 ns, a second step E2 of closing the second switch T2 is performed, which as a reminder is connected in parallel with the first switch T1; the first switch T1 being closed at the time of execution of the second closing step E2.

In other words, according to this first embodiment, the second closing step E2 concerns the closing of the second switch T2 connected in parallel with the first switch T1, wherein the microcontroller 30 transmits a second command signal Vgs2 for closing the second switch T2 at a second time t2. The second time t2 occurs after the end of the first time taken by the first switch to close Df1_T1. Advantageously, since the first midpoint PM1 is already at the electrical potential of the high point PH, due to the closing of the first switch T1, the second switch T2 does not incur a switching loss.

The method according to the present invention then proposes a third step E3 of opening the first switch T1 which is closed (see FIG. 4). Thus, the microcontroller 30 transmits a third command signal for opening the first switch T1 at a third time t3. The first switch T1 then opens within a time which will be called the first time taken by the first switch to open Do1_T1 which is intrinsic to the first transistor T1 and which corresponds to the switching time, i.e. the opening time of the switch starting from the opening command received.

Since the second switch T2 is still closed at the time when the first switch T1 opens, the voltage at the first midpoint PM1 is always equal to the voltage defined at the high point PH and the first switch T1 does not incur a switching loss.

After a first time taken by the first switch to open Do1_T1, which will be described in detail subsequently on the basis of the transmission of the first opening command signal, a fourth step E4 of opening the second switch T2 is performed. To do this, the microcontroller 30 transmits a second command signal for opening the second switch T2 at a fourth time t4.

In order to optimize the time when only one of the two transistors conducts, the method of the invention proposes measuring the actual switching time of the first transistor T1 in order to start the switching of the second transistor T2 in an optimum time in order to better distribute the transmitted electrical power between the two transistors T1 and T2.

To do this, the invention proposes, in one exemplary embodiment, a method for measuring the actual switching time of the first transistor T1 at each change in command or change in state of said first transistor T1. The electrical connector for measuring the actual switching time of a transistor is, in one exemplary embodiment, an electrical connector which already exists in the microcontroller 30.

As illustrated in FIG. 4, the method for measuring the actual switching time of the first transistor T1 consists of a first step M1 consisting in waiting for the end of the change in state of the first transistor T1 following a command signal for changing state. To do this, for example, it is proposed to scan the signal on the source of the first transistor T1 and to detect when it switches to a low threshold level for switching from an open state to a closed state or to detect when it switches to a high threshold level for reverse switching. The low threshold and the high threshold are fixed and determined according to the voltage levels of the electrical assembly in which the two transistors are arranged.

Once the actual change in state has been detected, the method consists of a second step M2 during which the actual switching time of the first transistor T1 is measured. To do this, during the second step M2, the time between the change in state of the first command signal for closing the first switch T1 corresponding to the first time t₁ and the value corresponding to the first time taken by the first switch T1 to close is measured, i.e. Df1_T1. For example, during the second step M2, the subtraction between the value corresponding to Df1_T1 and the value corresponding to the first time t₁ is performed. The value thus calculated is stored in a memory area of the microcomputer in a third step M3.

Advantageously, the method for measuring the actual switching time of the first transistor T1 as discussed above is also used when switching the first transistor T1 from a closed state to an open state.

To do this, the method according to the invention proposes measuring the actual switching time of the first transistor T1 during a fourth step M4 consisting in waiting for the end of the change in state of the first transistor T1 as a result of a command signal for changing state. To do this, for example, it is proposed to scan the signal on the source of the first transistor T1 and to detect when it switches to a high threshold level for switching from a closed state to an open state.

Once the actual change in state has been detected, the method measures the actual switching time for the first transistor T1 during a fifth step M5. To do this, during the fifth step M5, the time between the change in state of the first command signal for opening the first switch T1 corresponding to the third time t3 and the value corresponding to the first time taken by the first switch T1 to open Do1_T1 is measured. For example, during the fifth step M5, the subtraction between the value corresponding to Do1_T1 and the value corresponding to the third time t3 is performed. The value thus calculated is stored in a memory area of the dedicated microcomputer in a sixth step M6.

Thus, by virtue of the invention, it is possible to know with precision the time of the actual switching time of the first transistor T1 during the switching from the open state to the closed state and vice versa following the reception of a signal for changing state.

Advantageously, the method of the invention proposes, in order to optimally control the time when the first transistor T1 is switched alone, determining the actual switching time of the first transistor T1 from the open state to the closed state and also from the closed state to the open state by performing such measurements on n switchovers. For example, the method of the invention proposes, in one exemplary embodiment, performing one hundred measurements of the actual switching time for switching from the high state to the low state and one hundred measurements for measuring the actual switching time for switching from the low to the high state.

The methods and techniques for performing such measurements are easy for a person skilled in the art.

The method of the invention proposes using the average value of the actual switching time from the high state to the low state and the average value from the low state to the high state as respective values for generating the state-change signal for the second transistor T2, corresponding to t2. Thus, advantageously, the second transistor T2 will be switched in an optimum manner.

Advantageously, the invention also proposes, in one exemplary embodiment, performing the one hundred measurements every M minutes. For example, M is equal to one minute. Thus, the method of the invention will carry out one hundred measurements of the actual switching time of the first transistor T1 during its switching from the high state to the low state and it will carry out one hundred measurements of the actual switching time of the first transistor T1 during its switching from the low state to the high state. The values thus obtained will be used for the values of t2 and t4 for the following switching sequences.

Thus, it is possible to control the switching of the transistors and therefore to control the conduction losses of the first transistor T1.

The method as described above generates, in the case where the actual switching time of the first transistor T1 is greater than the average value calculated over the preceding cycle, conduction losses related to the switching of the second transistor T2 while the first transistor T1 is not yet fully switched.

In order to reduce the conduction losses in the case stipulated above, it is proposed, in another exemplary embodiment of the invention, to replace the step of averaging the n recorded values with a method step consisting in using a statistical 3 sigma technique on the n samples. This technique is well known to a person skilled in the art and will not be described in detail here.

Advantageously, with this method, the switching command t2 (and t4) on the second transistor T2 will only occur at a time corresponding to the statistically longest value of the actual switching time of the first transistor T1 measured over n switchovers during the preceding cycle. Thus, with this method, initiating the switching command of the second transistor T2 before the first transistor T1 is actually switched is advantageously avoided.

Advantageously, with this variant of the method of the invention, the switching losses occur only on the first transistor T1, allowing the second transistor T2 to switch without switching loss because the midpoint PM1 is already at the potential PH by the switching of the first transistor T1.

As a variant, the method of the invention is performed solely on the second transistor T2, the latter always switching first both when switching from the high state to the low state and when switching from the low state to the high state.

In another exemplary embodiment, the invention proposes carrying out the switching of the first transistor T1 and of the second transistor T2 in the following order: the first transistor T1 is switched first when switching from an open state to a closed state, and the second transistor T2 is switched first when switching from a closed state to an open state. Thus, by virtue of the invention, the two transistors incur switching losses in turn allowing the transistors on one and the same cell to age uniformly.

In another variant embodiment of the method of the invention, replacing the first closing step E1, the second closing step E2, the third opening step E3 and the fourth opening step E4, a first series of n_1 measurements of the actual switching time of the first transistor T1 when switching from a high state to a low state is first performed during a fifth step E5. The first transistor T1 is the first of the two transistors to be switched. The value n_1 is, for example, 100 samples. The measurement strategy is identical to that discussed previously.

The invention then proposes, during a sixth step E6, carrying out a second series of n_2 measurements of the actual switching time of the first transistor T1 when switching from a low state to a high state, the second transistor T2 being in a closed state for each measurement of the actual switching time of the first transistor T1.

The method of the invention then proposes, during a seventh step E7, a first series of p_1 measurements of the actual switching time of the second transistor T2 when switching from a high state to a low state. The second transistor T2 is the first of the two transistors to be switched. The value p_1 is, for example, 100 samples. The measurement strategy is identical to that discussed previously.

The invention then proposes, during an eighth step E8, carrying out a second series of p_2 measurements of the actual switching time of the second transistor T2 when switching from a low state to a high state, the first transistor T1 being in a closed state for each measurement of the actual switching time of the second transistor T2.

During a ninth step E9), the method consists in storing in a memory the values of the first time taken by the first transistor to close (Df_T1), the first time taken by the first transistor to open (Do_T1), the first time taken by the second transistor to close (Df_T2), and the first time taken by the second transistor to open (Do_T2). As a variant, n values are stored. As a variant, only the average values are stored.

During a tenth step E10), all the steps from E1) to E9) are performed a determined number of times, for example 100 times. The method then proposes, during an eleventh step E11) and a twelfth step E12), performing all the steps from E1) to E10) a determined number of times, for example 100 times, making it possible to obtain a relatively reliable representation of a possible drift of one of the transistors (T1) or (T2).

Ingeniously, by virtue of the invention, it is proposed and possible to track the drifts of the transistors T1, T2, T3, T4, T5, T6, T7, T8, T9, T10, T11, T12 of the power factor corrector circuit 21 in order to monitor the aging of said transistors. For this, the invention proposes carrying out said method each time the vehicle is started, for example, making it possible to track the change in the transistors over the life of the vehicle.

Ingeniously, the invention proposes storing the average values of the actual switching time for the transistors and tracking and processing the values thus calculated. The method for processing the values could be, for example, deducing a drift in the average value of the actual switching time for at least one transistor, for example the transistor T1, when switching from an open state to a closed state, which is indicative of presumed aging of said transistor.

In this case, the invention proposes generating an alert signal for the driver allowing a failure to be anticipated.

As a variant, the invention proposes, for example, in the case where a drift in the actual switching time of the first transistor T1 for example is observed, no longer making said first transistor T1 switch first in order to protect it from switching losses. Thus, for example, in such a case, the second transistor T2 is switched first and the first transistor T1 is switched second, making it possible, according to the strategy presented above, to limit the conduction losses during the switching of the first transistor T1 as much as possible.

Ingeniously, the switching time tests may be carried out only once each time the electric vehicle 10 is started, or every M minutes, for example every 10 minutes.

Advantageously, in the case where, despite the change in the switching order of the transistors, said first transistor continues a drift, then the method proposes to no longer activate said transistor to perform and to generate an alert signal informing the user of the vehicle of a notable malfunction.

1. A method for monitoring and managing conduction losses in an electronic circuit comprising at least a first transistor (T1) and a second transistor (T2), the first transistor (T1) and the second transistor (T2) being coupled in parallel, said method comprising:
a first step E1) consisting in commanding the first transistor (T1) so that it switches to a closed-circuit state, and in measuring a first time taken by the first transistor to close (Df_T1) following the command to switch said first transistor (T1) to the closed-circuit state,
a second step E2) consisting in commanding the second transistor (T2) so that it switches to a closed-circuit state, the command to switch the second transistor (T2) to a closed-circuit state occurring after a first determined time TM1,
a third step E3) consisting in commanding the first transistor (T1) so that it switches to an open-circuit state, and in measuring a first time taken by the first transistor to open (Do_T1) following the command to switch said first transistor (T1) to an open-circuit state,
a fourth step E4) consisting in commanding the second transistor (T2) so that it switches to an open-circuit state, the command to switch the second transistor (T2) to an open-circuit state occurring after a second determined time TM2,
a fifth step E5) consisting in commanding the second transistor (T2) so that it switches to a closed-circuit state, and in measuring a first time taken by the second transistor to close (Df_T2) following the command to switch said second transistor (T2) to the closed-circuit state,
a sixth step E6) consisting in commanding the first transistor (T1) so that it switches to a closed-circuit state, the command to switch the first transistor (T1) to a closed-circuit state occurring after a third determined time TM3,
a seventh step E7) consisting in commanding the second transistor (T2) so that it switches to an open-circuit state, and in measuring a first time taken by the second transistor to open (Do_T2) following the command to switch said second transistor (T2) to an open-circuit state,
an eighth step E8) consisting in commanding the first transistor (T1) so that it switches to an open-circuit state, the command to switch the first transistor (T1) to an open-circuit state occurring after a fourth determined time TM4,
a ninth step E9) consisting in storing in a memory the values of the first time taken by the first transistor to close (Df_T1), the first time taken by the first transistor to open (Do_T1), the first time taken by the second transistor to close (Df_T2), and the first time taken by the second transistor to open (Do_T2),
a tenth step E10) consisting in executing steps E1) to E9) at least n times, and
an eleventh step E11) consisting in taking an average of the n measurements of the first time taken by the first transistor to close (Df_T1), an average of the n measurements of the first time taken by the first transistor to open (Do_T1), an average of the n measurements of the first time taken by the second transistor to close (Df_T2), and an average of the n measurements of the first time taken by the second transistor to open (Do_T2),
a twelfth step E12) consisting in performing steps E1) to E11) m times, and
a thirteenth step E13) consisting in comparing the m values of the respective n averaged values,
wherein when at least one result of the comparison of the m values drifts from the average value by p% then generate a software alert and wherein when a result of the comparison of the m values of the n averaged values of the first time taken by the first transistor to close (Df_T1), or the m values of the n averaged values of the first time taken by the first transistor to open (Do_T1), or the m averaged values of the n values of the first time taken by the second transistor to close (Df_T2), or the m averaged values of the n values of the first time taken by the second transistor to open (Do_T2) drifts by p % then activate the transistor corresponding to the value that has drifted only after the other transistor.

2. The method for monitoring and managing conduction losses in an electronic circuit as claimed in claim 1, wherein if the observed drift of the m values of the n averaged values of said transistor activated only second continues a drift similar to that observed, for example of greater than p %, then activate a software alert.

3. The method for monitoring and managing conduction losses in an electronic circuit as claimed in claim 2, wherein if the drift of the m values of the n averaged values of said transistor activated only second has a drift of less than p % then activate said corresponding transistor first again.

4. The method for monitoring and managing conduction losses in an electronic circuit as claimed in claim 1, wherein the value of p % is equal to 10%.

5. The method for monitoring and managing conduction losses in an electronic circuit as claimed in claim 4, wherein if the drift of the m values of the n averaged values of said transistor activated only second has a drift of greater than p % then deactivate said transistor.

6. The method for monitoring and managing conduction losses in an electronic circuit as claimed in claim 1, wherein the processing function used is a mathematical three sigma method.

7. The method for monitoring and managing conduction losses in an electronic circuit as claimed in claim 1, wherein at least one of the two transistors is an IGBT transistor.

8. The method for monitoring and managing conduction losses in an electronic circuit as claimed in claim 1, wherein at least one of the two transistors is an SiC/GaN transistor.
